(19) United States
(12) Patent Application Publication
(10) Pub. No.: US 2009/0063482 A1
(43) Pub. Date: Mar. 5, 2009

(54) DATA MINING TECHNIQUES FOR ENHANCING ROUTING PROBLEMS SOLUTIONS

(76) Inventor: Menachem Levanoni, Poway, CA (US)

Correspondence Address: Stephen C. Kaufman;IBM CORPORATION, Intellectual Property Law Dept., P.O. Box 218, Yorktown Heights, NY, 10598, US

(21) Appl. No.: 11/849,429

(22) Filed: Sep. 4, 2007

(51) Int. Cl. G06F 17/30

(52) U.S. Cl. 707/6; 707/E17.014

(57) ABSTRACT

A computer method for enhancing routing problems solutions. The method includes the steps of providing a problem database comprising a compendium of problem history; providing a solution database comprising a compendium of at least one of routing problems solutions, routing information, and routing diagnostics; and, employing a data mining technique for interrogating the problem and solution databases for generating an output data stream, the output data stream correlating problem with solution.

### BACKGROUND OF THE INVENTION

1. Field of the Invention

This invention relates to methodology for utilizing data mining techniques in the area of routing problems solutions.

2. Introduction to the Invention

Data mining techniques are known and include disparate technologies, like neural networks, which can work to an end of efficiently discovering valuable, non-obvious information from a large collection of data. The data, in turn, may arise in fields ranging from e.g., marketing, finance, manufacturing, or retail.

### SUMMARY OF THE INVENTION

We have now discovered novel methodology for exploiting the advantages inherent generally in data mining technologies, in the particular field of routing problems solutions applications.

Our work proceeds in the following way.

We have recognized that a typical and important “three-part” paradigm for presently effecting routing problems solutions, is a largely subjective, human paradigm, and therefore exposed to all the vagaries and deficiencies otherwise attendant on human procedures. In particular, the three-part paradigm we have in mind works in the following way. First, a routing manager develops a problem database comprising a compendium of problem history—e.g., the problem's response to historical solution situations. Secondly, and independently, the routing manager develops in his mind a solution database comprising the routing manager's personal, partial, and subjective knowledge of objective facts culled from e.g., the scientific literature, or input from colleagues or other experts. Thirdly, the routing manager subjectively correlates in his mind the necessarily incomplete and partial solution database, with the problem database, in order to promulgate an individual's problem's prescribed routing solutions evaluation and cure.

This three-part paradigm is part science and part art, and captures one aspect of the problems associated with routing problems solutions. However, as suggested above, it is manifestly a subjective paradigm, and therefore open to human vagaries.

We now disclose a novel computer method which can preserve the advantages inherent in this three-part paradigm, while minimizing the incompleteness and attendant subjectivities that otherwise inure in a technique heretofore entirely reserved for human realization.

To this end, in a first aspect of the present invention, we disclose a novel computer method comprising the steps of:
i) providing a problem database comprising a compendium of routing problems history;
ii) providing a solution database comprising a compendium of at least one of routing problems solutions, routing information, and routing diagnostics;
and
iii) employing a data mining technique for interrogating said problem and solution databases for generating an output data stream, said output data stream correlating routing problem with history solution.

The novel method preferably comprises a further step of updating the step step i) history problem database, so that it can cumulatively track the problem history as it develops over time. For example, this step i) of updating the problem database may include the results of employing the step iii) data mining technique. Also, the method may comprise a step of refining an employed data mining technique in cognizance of pattern changes embedded in each database as a consequence of solution results and updating the problem database.

The novel method preferably comprises a further step of updating the step ii) solution database, so that it can cumulatively track an ever increasing and developing technical routing problems solutions literature. For example, this step ii) of updating the solution database may include the effects of employing a data mining technique on the problem database. Also, the method may comprise a step of refining an employed data mining technique in cognizance of pattern changes embedded in each database as a consequence of solution results and updating the solution database.

The novel method may employ advantageously a wide array of step iii) data mining techniques for interrogating the problem and solution database for generating an output data stream, which output data stream correlates problem problem with solution. For example, the data mining technique may comprise inter alia employment of the following functions for producing output data: classification-neural, classification-tree, clustering-geographic, clustering-neural, factor analysis, or principal component analysis, or expert systems.

In a second aspect of the present invention, we disclose a program storage device readable by machine to perform method steps for providing an interactive routing problems solutions database, the method comprising the steps of:
i) providing a problem database comprising a compendium of problem history;
ii) providing a solution database comprising a compendium of at least one of routing problems solutions, routing information, and routing diagnostics;
and
iii) employing a data mining technique for interrogating said problem and solution databases for generating an output data stream, said output data stream correlating routing problem with solution.

In a third aspect of the present invention, we disclose a computer comprising:
i) means for inputting a problem database comprising a compendium of problem history;
ii) means for inputting a solution database comprising a compendium of at least one of routing problems solutions, routing information, and routing diagnostics;
iii) means for employing a data mining technique for interrogating said solution databases;
and
iv) means for generating an output data stream, said output data stream correlating routing problem with solution.

### BRIEF DESCRIPTION OF THE DRAWING

The invention is illustrated in the accompanying drawing, in which

FIG. 1 provides an illustrative flowchart comprehending overall realization of the method of the present invention;

FIG. 2 provides an illustrative flowchart of details comprehended in the FIG. 1 flowchart;

FIG. 3 shows a neural network that may be used in realization of the FIGS. 1 and 2 data mining algorithm;
and

FIG. 4 shows further illustrative refinements of the FIG. 3 neural network.

### DETAILED DESCRIPTION OF THE PRESENT INVENTION

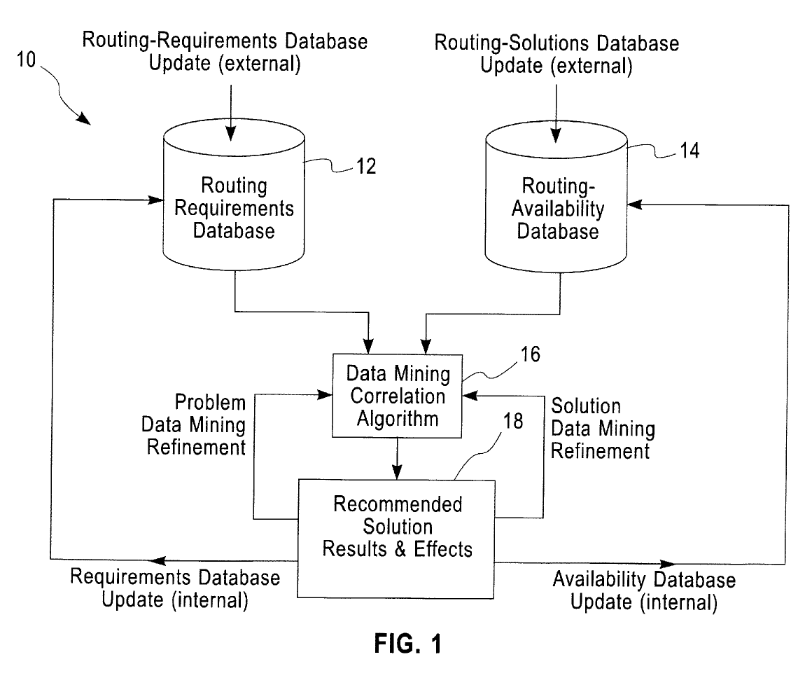

The detailed description of the present invention proceeds by tracing through three quintessential method steps, summarized above, that fairly capture the invention in all its sundry aspects. To this end, attention is directed to the flowcharts and neural networks of FIGS. 1 through 4, which can provide enablement of the three method steps.

FIG. 1, numerals 10-18, illustratively captures the overall spirit of the present invention. In particular, the FIG. 1 flowchart (10) shows a problem database (12) comprising a compendium of problem history, and a solution database (14) comprising a compendium of at least one of routing problems solutions, routing information, and routing diagnostics. Those skilled in the art will have no difficulty, having regard to their own knowledge and this disclosure, in creating or updating the databases (12,14) e.g., conventional techniques can be used to this end. FIG. 1 also shows the outputs of the problem database (12) and solution database (14) input to a data mining condition algorithm box (16). The data mining algorithm can interrogate the information captured and/or updated in the problem and solution databases (12,14), and can generate an output data stream (18) correlating problem with solution. Note that the output (18) of the data mining algorithm can be most advantageously, self-reflexively, fed as a subsequent input to at least one of the problem database (12), the solution database (14), and the data mining correlation algorithm (16).

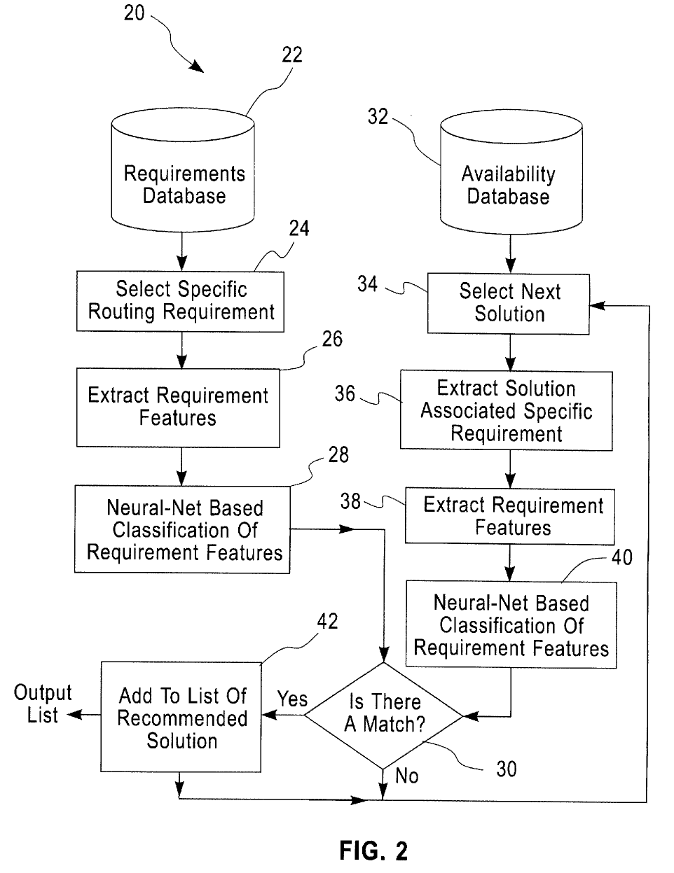

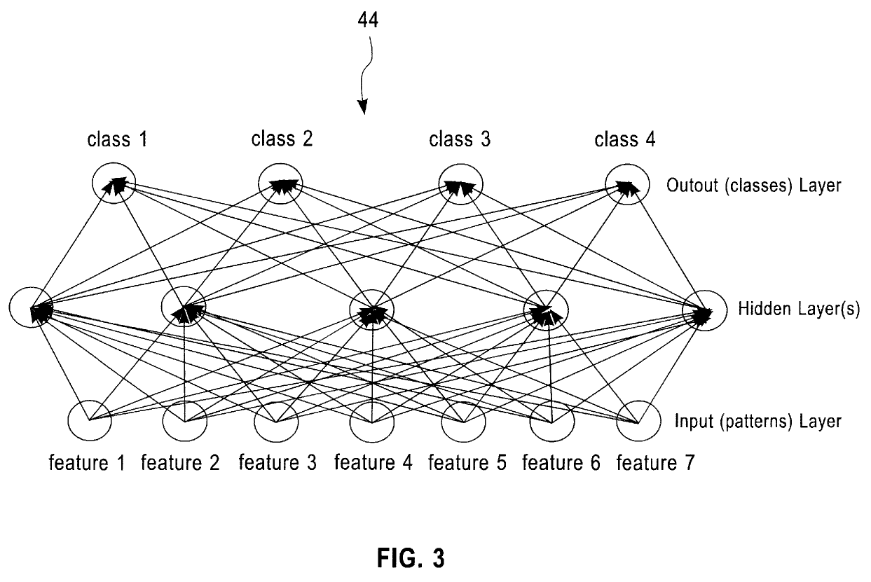

Attention is now directed to FIG. 2, which provides a flowchart (20-42) that recapitulates some of the FIG. 1 flowchart information, but adds particulars on the immediate correlation functionalities required of a data mining correlation algorithm. For illustrative purposes, FIG. 2 comprehends the data mining correlation algorithm as a neural-net based classification of problem features, e.g., wherein a problem feature for say, function minimization, may include function type, number of variables, acceptable solution speed range, desired solution requirements, acceptable solution accuracy, etc.

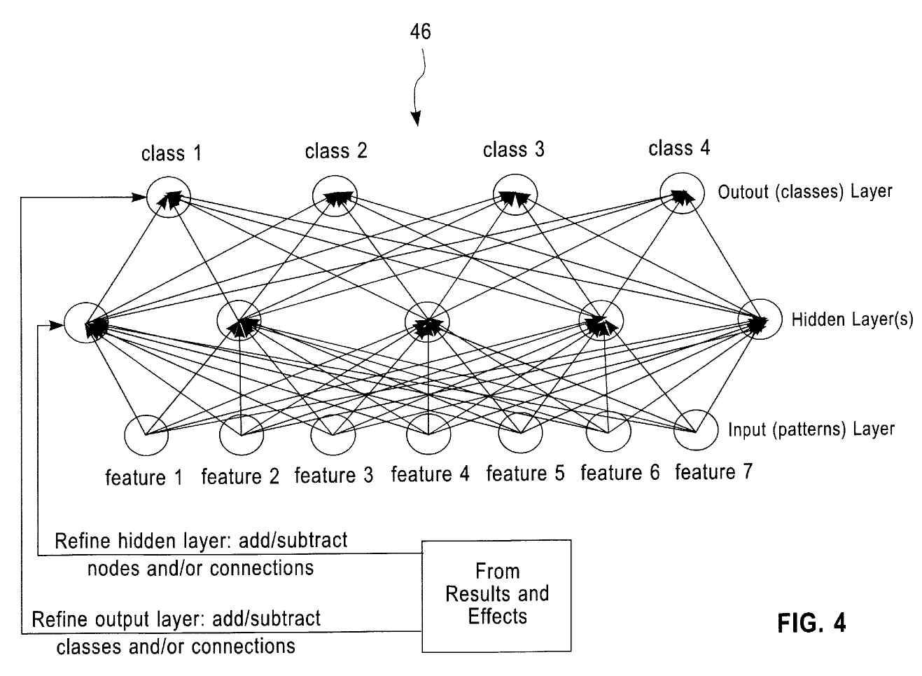

FIG. 3, in turn, shows a neural-net (44) that may be used in realization of the FIGS. 1 and 2 data mining correlation algorithm. Note the reference to classes which represent classification of input features. The FIG. 3 neural-net (44) in turn, may be advantageously refined, as shown in the FIG. 4 neural-net (46), to capture the self-reflexive capabilities of the present invention, as elaborated above.

What is claimed:

1. A computer method comprising the steps of:
i) providing a problem database comprising a compendium of problem history;
ii) providing a solution database comprising a compendium of at least one of routing problems solutions, routing information, and routing diagnostics;
and
iii) employing a data mining technique for interrogating said problem and solution databases for generating an output data stream, said output data stream correlating routing problem with solution.

2. A method according to claim 1, comprising a step of updating the problem database.

3. A method according to claim 2, comprising a step of updating the problem database so that it includes the results of employing a data mining technique.

4. A method according to claim 1, comprising a step of updating the solution database.

5. A method according to claim 4, comprising a step of updating the solution database so that it includes the effects of employing a data mining technique on the problem database.

6. A method according to claim 2, comprising a step of refining a employed data mining technique in cognizance of pattern changes embedded in each database as a consequence of updating the problem database.

7. A method according to claim 4, comprising a step of refining a employed data mining technique in cognizance of pattern changes embedded in each database as a consequence of updating the solution database.

8. A program storage device readable by machine, tangibly embodying a program of instructions executable by the machine to perform method steps for providing an interactive routing problems solutions database, the method comprising the steps of:
i) providing a problem database comprising a compendium of problem history;
ii) providing a solution database comprising a compendium of at least one of routing problems solutions, routing information, and routing diagnostics;
and
iii) employing a data mining technique for interrogating said problem and solution databases for generating an output data stream, said output data stream correlating routing problem with solution.

9. A computer comprising:
i) means for inputting a problem database comprising a compendium of problem history;
ii) means for inputting a solution database comprising a compendium of at least one of routing problems solutions, routing information, and routing diagnostics;
iii) means for employing a data mining technique for interrogating said problem and solution databases;
and
iv) means for generating an output data stream, said output data stream correlating routing problem with solution.
